(19) United States
(12) Patent Application Publication
(10) Pub. No.: US 2007/0030921 A1
(43) Pub. Date: Feb. 8, 2007

(54) Method for data communication between a base station and a transponder

(75) Inventor: Ulrich Friedrich, Ellhofen (DE)

Correspondence Address: MCGRATH, GEISSLER, OLDS & RICHARDSON, PLLC, P.O. BOX 1364, FAIRFAX, VA, 22038-1364, US

(73) Assignee: ATMEL Germany GmbH

(21) Appl. No.: 11/580,850

(22) Filed: Oct. 16, 2006

Related U.S. Application Data
(63) Continuation of application No. PCT/EP05/03801, filed on Apr. 12, 2005.

(30) Foreign Application Priority Data
Apr. 14, 2004 (DE) DE 102004018542.5

(51) Int. Cl. H04L 27/04

(52) U.S. Cl. 375/300

(57) ABSTRACT

A method is disclosed for wireless data communication between a base station and at least one transponder by a high-frequency electromagnetic carrier signal onto which information packets are modulated, each information packet comprising a header section, a middle section, and a terminating end section. This end section s provided with at least two EOF symbols which together indicate the end of an information packet. An additional information field is provided which is inserted into the end section between two EOF symbols and contains additional information. The invention relates further to a base station and a data communication system.

This nonprovisional application is a continuation of International Application No. PCT/EP2005/003801, which was filed on Apr. 12, 2005, and which claims priority to German Patent Application No. DE 102004018542, which was filed in Germany on Apr. 14, 2004, and which are both herein incorporated by reference.

### BACKGROUND OF THE INVENTION

1. Field of the Invention

The present invention relates to a method for wireless data communication between a base station and at least one transponder by a high-frequency electromagnetic carrier signal, onto which information packets are modulated, whereby each information packet has a header section, a middle section, and a terminating end section, whereby the middle section has at least two EOF symbols, which together indicate the end of an information packet. The invention relates further to a base station and a data communications system.

2. Description of the Background Art

The invention falls within the realm of transponder technology and in particular within the field of contactless communication for the purpose of identification. Although it can be used in principle in any communication systems, the present invention and its underlying problem are explained below with reference to RFID communication systems and their applications. Here RFID stands for “radio frequency identification.” Reference is made on the general background of this RFID technology to the “RFID-Handbuch” [RFID Handbook] of Klaus Finkenzeller, Hanser Verlag, third updated edition, 2002.

In the case of transponders, an electromagnetic signal transmitted by the base station is received by the transponder and demodulated. Active, semipassive, and passive transponders are differentiated here depending on the design of their energy supply. In contrast to active transponders, passive transponders do not have their own energy supply, so that the energy necessary in the transponder for demodulating and decoding the received electromagnetic signal must be obtained from this electromagnetic signal itself transmitted by the base station. In addition to this unidirectional energy transfer, bidirectional data communication typically also occurs between the base station and transponder.

The basis for the bidirectional data transmission between the base station and transponder forms a communication protocol, which specifies, in addition to the data information to be transmitted, also the control information for the data communication.

A generic RFID communication protocol for a known data communication between a base station and transponder is described in German Patent Application DE 101 38 217 A1, which corresponds to U.S. Publication No. 20030133435, and which is incorporated herein by reference, particularly in regard to the control mechanism via the header section of a data protocol, by which the number of symbols used for coding in the data region and their identification are defined. Accordingly, an information packet to be transmitted from the base station to a transponder has at least one header section, a middle section, and an end section. The header section defines the number of data to be transmitted and their identification. The middle section contains the data to be transmitted in each case. The end of the information packet is communicated in the end section to the receiver of the data transmitted in each case. The data communication is protected with protection mechanisms, such as, for example, a CRC protection field or parity bits.

A generic RFID method and system for bidirectional data communication is also the subject of the so-called Palomar Project, which was established by the European Commission as part of the so-called IST program. With respect to the content of this Palomar project, reference is made to the related, generally available publication of the European Commission of Jan. 11, 2002, which corresponds substantially to the ISO standard 18000-6.

For further background on bidirectional data communication between a base station and transponder, reference is made further to the Unexamined German Patent Applications DE 102 04 317 A1, DE 100 50 878 A1, and DE 102 04 346 A1, which correspond respectively to U.S. Publication Nos. 20050094720, 20020044595, 20050128130, which are incorporated herein by reference, and made to European Patent EP 473 569 B1, which corresponds to U.S. Pat. No. 5,345,231.

In most UHF- and microwave-based RFID systems and/or sensor systems, the data communication between the base station and transponder is initiated first by the base station with the base station transmitting a request signal (command, data request) to the various transponders located within the vicinity of the base station. The transponder(s) participating in the data communication typically respond to this request with a response signal (response), but only if the transponder(s) has (have) received a complete and valid command from the base station. The transponder can then be operated synchronously or asynchronously relative to the base station.

In the case of passive transponders, for the data communication between transponder and base station the generally known backscatter technique is utilized, in which part of the power transmitted by the base station is reflected from the transponder antenna and is thus transmitted back to the base station. The reflection properties (=reflecting cross section) of the transponder antenna can be influenced by changing a load connected thereto, for example, by turning on and off a load resistor, connected parallel to the transponder antenna, in the clock of the data stream to be transmitted. The power reflected by the transponder can thus be modulated in its amplitude, so that a data communication between transponder and base station is possible thereby. This technique will hereafter also be called the backscatter technique and the corresponding transponder a backscatter-based transponder.

If the load resistor in the transponder is turned on and off very rapidly, i.e., with a very high clock frequency, decided spectral lines arise, the so-called auxiliary carriers or subcarriers, which can now be used with suitable modulation for the data retransmission in the return link. A frequency change in the carrier signal transmitted by the base station does not occur here.

Active systems are also used in addition to these backscatter-based systems. In these active systems, the so-called transponder, independent of the received signal, generates a signal to be transmitted, which it actively emits to the base station. In such active systems, the frequency of the backward channel to the base station must be changed compared with the signal received by the base station according to relevant HF regulations or to improve the data transmission properties. In response to the request from the base station, the active transponder therefore transmits the response signals back the base station at another frequency. Nevertheless, in such a data communication, the base station functioning as a master must report to the active transponders functioning as slave for the frequency (or channel) desired for the data transmission in the return link, so that the specific active transponder can retransmit the data in the return link at the appropriate frequency specified by the base station.

The information on the desired frequency is transmitted by the transponder typically within the data field of an information packet, for example, in the parameter field of the forward link. In addition or alternatively, it would also be conceivable that this frequency information is contained in the header section of the information packet in the forward link. This use of the header section of an information packet to control the data communication is, for example, the subject of the German Patent Application DE 101 38 217 A1.

Modern RFID data communication systems are now to be designed so that backscatter-based transponders can be operated together with active transponders in one field. For this reason, it is desirable that the data communication occurs based on an instruction structure, which is compatible with both backscatter-based transponders and active transponders. This reduces additional expense in the processing of data signals transmitted by the transponder.

In fact, using conventional data structures, it is possible for a base station to obtain information on the transponder types located in the field. Nevertheless, it is problematic here that active transponders continue to require information on the frequency to be used in the return link. This additional information, however, should not negatively impact the data communication and thereby the information exchange during simultaneous operation of the base station with the backscatter-based transponders.

This requirement is currently not met however, i.e., by current data communication systems, because in the protocol of the data transmission, which is designed for both active transponders and backscatter-based transponders, additional commands, required for information on the backward channel to be used, are of necessity also evaluated by the backscatter-based transponder. However, these backscatter-based transponders do not require this information. Backscatter-based transponders in this case would therefore transmit error codes back to the base station, with which they inform the base station that it is not possible for them to execute this instruction.

To avoid this constellation, a backscatter-based transponder would have to be designed, nevertheless, to be able to evaluate this information not intended for it and after the evaluation to discard it as not relevant. To accomplish this, however, an evaluation mechanism, costly in terms of circuitry engineering, would be needed in the transponder. The appropriate command codes for the additional information would also have to be stored in the memory in the backscatter-based transponder. The additional resulting cost for circuit design, particularly for the evaluation circuit and for the additional memory expenditure, would further increase the cost of backscatter-based transponders without improving its functionality.

Furthermore, these additional commands reduce the maximum possible common instruction set, which thereby also reduces the functionality of the corresponding transponders. To be able to assure a constant functionality, the instruction set would have to be extended accordingly, which in turn is associated with an additional circuitry engineering cost and thereby cost disadvantages.

Based on these problems, therefore, thus far there are no so-called mixed RFID systems, in which both active transponders and backscatter-based transponder systems are used. The different data protocols used for active transponders and backscatter-based transponders primarily are regarded as the main problem.

In US 2002/0196751 A1, a frame format is described, whereby packets are packaged in frames, and so-called brackets are arranged in a frame if a packet boundary extends within a frame.

In WO 98/34208, a frame format is described, whereby data fields within a frame are separated from one another by so-called End of Field markers. To mark the end of the frame, a so-called End of Message marker is provided.

### SUMMARY OF THE INVENTION

It is therefore an object of the present invention to provide an effective data communication for mixed RFID systems. In particular, certain specific information is to be transmitted for active transponders without at the same time interfering with backscatter-based transponders located in the same field. Another object of the present invention is to thereby avoid as much as possible intervention in the protocol of the data communication. Another object of the present invention is to keep the instruction set in a mixed operation of active and backscatter-based transponders as small as possible.

A method for wireless data communication is disclosed between a base station and at least one transponder by a high-frequency electromagnetic carrier signal, onto which information packets are modulated, whereby each information packet has a header section, a middle section, and a terminating end section, whereby the end section has at least two EOF symbols, which together indicate the end of an information packet, whereby an additional information field is provided that is inserted between two EOF symbols in the end section and that contains additional information.

A base station is also disclosed for data communication with at least one transponder, with a receiving/transmitting device for transmitting high-frequency carrier signals and for receiving the corresponding response signals from at least one transponder, with a control device which controls the data communication with at least one transponder and is designed to insert an additional information field, which contains additional information, between two EOF symbols in an end section of the forward link of a transmitted information packet particularly during use of the method of the invention.

Further, a mixed data communication system is disclosed, particularly an RFID data communication system, with at least one first active transponder, with at least one second passive transponder, and with a base station, which is designed to communicate with the first and second transponders for wireless data communication.

The draft protocol for the aforementioned Palomar system (also see the submission for ISO Standard 18000-6 of February 2002) provides that in the EOT end section each time precisely two EOF symbols are provided both in the data stream for the forward link and in the data stream for the return link. In the Palomar concept, the EOT end section in the protocol for the data transmission is configured such that as many symbols and data as desired can be placed within this EOT end section, without interference with the transponders participating in such a data communication system. The return link is initiated or completed for further data communication only when the transponder has received both EOF symbols of the EOT end section at the place in the protocol specified for this.

The idea forming the basis for the present invention is that a field with additional information is placed between these two EOF symbols of the EOT end section; this field is used very advantageously for further information transmission particularly for active transponders.

Because the specific decoding instructions are known to a specific transponder, this transponder is now also capable of receiving and decoding the data placed in the field between the two EOF symbols. This field, designated hereafter in shorter form as an additional information field, between the two EOF symbols can therefore have, more or less, many data bits depending on the application and need. These data bits can be configured in the form of logic zeros (“0”) or logic ones (“1”). Whether a data bit now represents a logic zero or logic one depends substantially on the time interval of the so-called “notches”, therefore the voltage dips of the carrier signal, and thereby on the corresponding duration of the symbol.

The additional information field can be inserted by the base station in the forward link of a data communication.

The advantage of the present invention is, inter alia, also that the same instruction set can be used in mixed communication systems, designed for data communication with both active and passive transponders. The processing time in such mixed communication systems can be drastically reduced in this way. This enables a high efficiency of the data communication system, because additional instructions need not be resorted to here.

The additional symbols placed in the information field and their data content are ignored by the backscatter-based transponders, designated hereafter in short as passive transponders, because these do not expect any data between the two EOF symbols. These data also do not interfere with the passive transponder, because it waits for the subsequent second EOF symbol after the first EOF symbol, regardless of whether other non-EOF symbols are present between these. The number of symbols between the two EOF symbols also plays no role here, because it is only important for the mode of operation of the passive transponder that the one information packet is ended with precisely two EOF symbols, no matter the sequence.

The additional information field can provide information for the assignment of the return link for an active transponder participating in the data communication.

Active transponders typically have their own clock generator. Advantageously, data for the assignment of the return link of the active transponder can now be placed in this additional field. There, the additional information field can be used, for example, for frequency information for the data transmission in the return link, therefore, for such information already provided on the base station side, on which channel and thereby at which frequency the data transmission via the return link is to occur.

In an embodiment, the additional information field can be provided between the two EOF symbols also to provide the clock information. Such clock information can be used advantageously particularly for transponders without their own chip-internal clock generator, such as, for example, passive transponders. This makes possible a current-saving alternative for transponder-side clock generation.

Many transponders have their own clock generator, which is made, for example, as a voltage-controlled oscillator or current-controlled oscillator. It can also occur with such clock generators that the clock generated by these clock generators does not precisely correspond to the desired reference clock. In an embodiment, a suitable correction value for the transponder-side generated clock can be obtained from it from the time interval of two notches or the number of counted clocks of the reference clock.

Passive transponders, in contrast, do not require this type of information. There, the additional information field can be used in addition or alternatively as clock information, provided that the passive transponder has, for example, no clock generator of its own (on-chip VCO). Significant energy can be saved in this way in passive transponders, because here the clock information need not be generated within the transponder, which would be very costly in terms of energy.

Alternatively, it can be provided that the passive transponder verifies the clock it generates from the information in the additional information field, provided it contains its own clock generator.

In another embodiment, the symbols transmitted by the base station in the additional information field can be used as reference symbols for the control of a voltage-controlled (VCO) or current-controlled oscillator (ICO). For this purpose, the number of clocks of a reference clock between two neighboring notches is counted. This number of clocks is therefore a function of the time interval between two notches and can be used advantageously as a reference for the transponder-side clock.

Different countries provide different bands for data retransmission in the return link. This can be taken into account in that different bands are used for the return link for different countries. In an embodiment, information related to the different bands for the different countries can be provided in the additional information field in addition or alternatively to the information for the channel (frequency) to be used for the return link.

The provision of additional commands means an additional expense both in the base station and in the corresponding transponders. In particular, this requires first an increased memory expenditure, because the corresponding commands must be stored in the memory. In addition, an increased expense is also required for evaluation, i.e., for demodulation and decoding of these additional commands. For these reasons, the effort is always made to keep the instruction set and thereby the total number of instructions as small as possible. However, it is moreover necessary for many applications to provide additional instructions, apart from the available instruction set, for example, to allow for an increased functionality of the data system in general and for the transponder in particular. The advantage of the present invention is also that, in addition to the specified instruction set, which is defined, for example, in the command field of the data section, additional instructions can be placed in the additional information field in the EOT end section, without an associated expansion of the existing instruction set.

This additional command level can be designated for special transponders, for example, only for the active transponders or only for the passive transponders. An additional command level can be introduced within the data section in this way without increasing the instruction set; this advantageously has no or only a minimal impact on the data communication.

In further embodiments of the invention, further information can also be placed in the additional information field, thus, for example, the employed type of modulation, another protection level, additional parameter data, additional address data, additional program data, etc.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a basic structure (protocol) of an information packet for data communication between a base station and transponder;

FIG. 2 illustrates a structure of an information packet for the forward link of a data communication in the case of an additional information field inserted according to an embodiment of the invention between two EOF symbols in the EOT end section; and

FIG. 3 illustrates in a block diagram, the structure of an RFID communication system containing a base station and at least one active transponder and at least one passive transponder.

### DETAILED DESCRIPTION

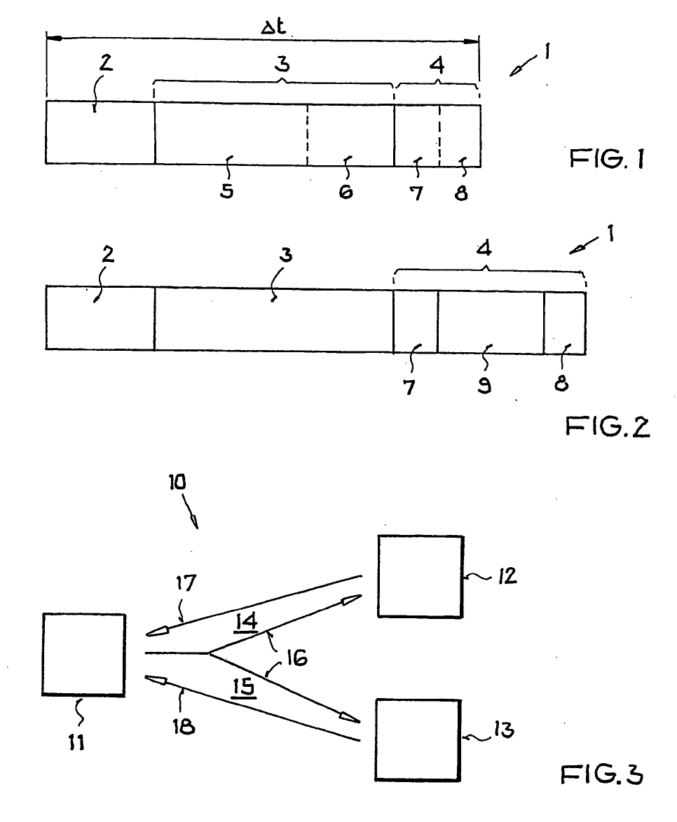

In the figures of the drawing, the same or functionally identical elements, data, and signals, if not specified otherwise, were provided with the same reference characters. The presentations in FIGS. 1 and 2 refer in each case to the time sequence of a specific data communication in relation to the information packet.

The data communication between the base station and transponder defines a channel, which is designated below as a forward link VL (or downlink). Conversely, the data communication from the transponder back to the base station designates a channel, which is generally designated as a return link RL (or uplink). In addition to the data communication in the return link RL, in so-called backscattering-based transponders, data communication also occurs between transponder and base station in which a transmitted signal is scattered back to the transmitter with use of the backscatter cross section of the antenna of the receiver. This method is also generally known as the backscatter method. This data communication with the backscatter technique can be used both in the forward and return link.

The data transmission occurs by an amplitude-modulated carrier wave, which is transmitted on the base station side and is returned by the transponder. The data modulated onto the carrier wave are generated by pulse pause modulation of the carrier signal, in that the transmitter of the base station turns an electromagnetic field on or off for the carrier signal for certain time spans. In the transponder, thus on the input side, a voltage signal is generated, which is derived from the field strength of the carrier signal and has voltage dips, also generally called “notches.” The data information now occurs within the time span between two such voltage dips. This time span now includes in each case a data symbol or briefly a symbol. The field gaps during which the transmitter of the base station is turned off and/or no electric magnetic carrier signal is transmitted, thus to a certain extent forms a separator between two successive symbols. The significant value of a data symbol is determined from the time span during which the electromagnetic field is turned on and thus the carrier signal has its nominal amplitude. A symbol can now contain a digital code, for example, a logic zero (“0”) or a logic one (“1”), or additional information, such as, for example, an EOF symbol.

FIG. 1 shows the basic structure of a conventional information packet 1, as it is used for data communication between a base station and a transponder.

Information packet 1 has a header section 2, a middle section 3, and an end section 4.

The number of data symbols to be transmitted and their identification are defined in header section 2. This is necessary to be able to establish the precise position where a specific field begins within middle section 3 or end section 4. This need results from the fact that the duration At of an information packet 1 in general and the individual fields 24 in particular is not fixedly defined and is constant as far as possible, as is the case in many time slot-based data transmission methods. Rather, the duration At and thereby the information transmitted within an information packet 1 can vary more or less greatly depending on the application. The data to be transmitted in middle section 3 are coded with the identification within header section 2. In particular, header section 2 specifies reference times which are used for the further data transmission in middle section 3 or a data field 5. The speed of the data communication between the base station and transponder is also established via header section 2, for example, by the frequency of a free-running oscillator in the transponder. Moreover, in an embodiment, header section 2 can also contain control information for the fields, following header section 2, of middle section 3 and end section 4.

Middle section 3 generally includes a data field 5 and a protection field 6 immediately following this data field 5. Coded data symbols are transferred in middle section 3. Depending on the desired application, the most diverse data structures (long command, short command) can be provided here, which will not be described in greater detail here, however.

The content of end section 4 indicates the end of the transmitted information packet 1 to the specific receiver of this packet. In the case of the aforementioned Palomar system, end section 4 has precisely two so-called EOT symbols (EOT=end of transmission).

The structure of an information packet 1 in the return link RL corresponds substantially to that of the forward link VL or is sometimes even identical to it.

FIG. 2 shows the structure of an information packet according to the invention for the forward link of a data communication.

According to the invention, an additional information field 9 is inserted into the structure of an information packet 1. Information field 9 is inserted here in the EOT end section 4, namely, between the two EOF symbols 7, 8 of EOT end section 4. This additional information field can contain, for example, the following information:

Channel information: The base station in additional information field 9 can provide information on the frequency to be used for the return link RL in the case of data communication with an active transponder.

Band information: The base station in addition or alternatively can provide in additional information field 9 country-specific information for the bands used in the different countries. The information in additional information field 9 can be used in this way to indicate which country-specific band and thereby which frequencies are to be used for the data communication in the return link RL.

Clock information: The base station can transmit clock information in additional information field 9 particularly for passive transponders that do not have their own clock supply.

Clock correction: In addition or alternatively to the transmission of the clock information, this clock information can also be used to provide a suitable correction value for this transponder clock in transponders, which have their own clock generator and thereby their own transponder-side generated clock.

FIG. 3 shows the structure of an RFID communications system according to the invention using a block diagram.

The communication system designated with reference character 10 has a base station 11 and two transponders 12, 13. Here, one of the transponders is made as an active transponder 12 and the other transponder as a passive, backscatter-based transponder 13. Base station 11 and the two transponders 12, 13 are in communication with one another. This so-called mixed communication system is designed as a master-slave communication system, the base station functioning as the master and the transponders 12, 13 each as slaves.

There is a first bidirectional transmission path 14 between base station 11 and first transponder 12 and a second bidirectional transmission path 15 is provided between base station 11 and second transponder 13. Base station 11 now transmits as part of these transmission paths 14, 15 data signals 16, which can be received by both transponders 12, 13. After the receipt of a complete, valid command, a specific transponder 12, 13 transmits signals 17, 18 via the return link of transmission path 14, 15 to base station 11, which receives and evaluates this signal 17, 18.

It is assumed that the protocol of signals 16 transmitted by base station 11 to transponder 12, 13 has a structure corresponding to that shown in FIG. 2. In particular, these signals 16 contain in additional information field 9, for example, information on the frequency to be used for the data transmission in the return link of active transponder 12. This frequency information is used by active transponder 12 for data retransmission. In contrast, this information is ignored by passive transponder 13; i.e., the information contained in additional information field 9 plays no role for the data transmission from passive transponder 13 to base station 11.

Although the present invention was described above with reference to a preferred exemplary embodiment, it is not limited thereto but can be modified in many ways.

The invention is not limited in particular exclusively to RFID systems, but of course can also be expanded, for example, to item identification. The individual items frequently need not be uniquely identified. It is often also sufficient here that a presence, for example, of a defective item can be ruled out. This is also usually called “nonunique” identification. During operation of the transponder in this regard, it has the function of a remote sensor. The invention therefore also refers explicitly to such transponders designed as sensors, in which a communication for reading out and writing of data of a data carrier or sensor is undertaken. A temperature sensor, pressure sensor, or the like are mentioned as examples of such so-called remote sensor application.

The invention is also not limited exclusively to a data communications system according to the aforementioned Palomar system, but can be used advantageously in any generic data communication system, in which the structure of the communication protocol has this type of EOT section with at least two EOF symbols.

The data communication system and method described above were described with the help of the “reader talks first” principle.

The “tag talks first” principle in which the base station first waits for a request from a transponder would naturally also be conceivable. Nevertheless, this principle has a poor reaction time, so that primarily the “reader talks first” principle is employed preferably in modern so-called “long range” data communications systems.

FIG. 3 presented the structure of the data communication system intentionally in a very simplified way for the sake of clarity. It goes without saying that this data communication system, of course, can have a pluraltiy of different active and/or passive transponders.

The method of the invention also need not be designed for the mixed operation of active and passive transponders, but also functions if only active or passive transponders are present.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for wireless data communication between a base station and at least one transponder by a high-frequency electromagnetic carrier signal, the method comprising:
modulating information packets onto the carrier signal, each information packet having a header section, a middle section, and a terminating end section, the end section having at least two EOF symbols, which together indicate an end of the information packet; and
providing an additional information field, which is inserted between two EOF symbols in the end section, the additional information field containing additional information.

2. The method according to claim 1, wherein the additional information field is inserted by the base station in the forward link of the data communication.

3. The method according to claim 1, wherein in a protocol of the data transmission a similar instruction set is used both for active transponders and for passive transponders.

4. The method according to claim 1, wherein passive transponders participating in the data communication whose protocol does not support the additional information field and is thereby not capable of identifying its content, ignores the additional information in the additional information field.

5. The method according to claim 1, wherein the additional information field provides information for the assignment of the return link for an active transponder participating in the data communication.

6. The method according to claim 1, wherein the additional information field provides frequency information for the data transmission in the return link.

7. The method according to claim 1, wherein the additional information field provides clock information for a transponder participating in the data communication.

8. The method according to claim 1, wherein the additional information field provides reference symbols for control of a voltage-controlled and/or a current-controlled oscillator of a transponder participating in the data communication.

9. The method according to claim 1, wherein the additional information field provides country-specific information for the data retransmission in the return link, the country-specific information containing information on bands to be used in the different countries.

10. The method according to claim 1, wherein the additional information field has an additional command level, the additional command level having additional instructions in addition to the instructions provided in a command field of a data section.

11. The method according to claim 10, wherein the additional command level is designated only for the active transponders or only for the passive transponders.

12. The method according to claim 1, wherein the additional information field provides information for the type of modulation to be employed, an additional protection level, additional parameter data, additional address data, and/or additional program data.

13. A base station for data communication with at least one transponder, the base stating comprising:
a transmitting/receiving device for transmitting high-frequency carrier signals and for receiving the corresponding response signals from the at least one transponder; and
a control device, which controls the data communication with at least one transponder and inserts an additional information field that contains additional information between two EOF symbols in an end section of a forward link of a transmitted information packet.

14. A data communication system comprising:
at least one first active transponder;
at least one second passive transponder; and
a base station that communicates with the first and second transponder by inserting an additional information field that contains additional information between two EOF symbols in an end section of a forward link of a transmitted information packet.
